(19) United States
(12) Patent Application Publication
(10) Pub. No.: US 2007/0149156 A1
(43) Pub. Date: Jun. 28, 2007

(54) Information processing apparatus and control method thereof

(75) Inventor: Kazuya Fukushima, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/634,959

(22) Filed: Dec. 7, 2006

(30) Foreign Application Priority Data
Dec. 28, 2005 (JP) 2005-377118

(51) Int. Cl. H04B 17/00; G08B 21/00

(52) U.S. Cl. 455/226.4; 340/686.1

(57) ABSTRACT

According to one embodiment, location information of own apparatus of a personal computer, location information of a serer capable of making communications with the personal computer, and bearing information are received, a direction of the own apparatus to the server is discriminated by using the received location information of own apparatus, location information of the serer, and bearing information, and the discriminated direction is displayed if sensitivity of a radio wave received by a 3G communication unit is the sensitivity which allows the own apparatus to make communications with the server.

### CROSS-REFERENCE TO RELATED APPLICATIONS

This application is based upon and claims the benefit of priority from Japanese Patent Application No. 2005-377118, filed Dec. 28, 2005, the entire contents of which are incorporated herein by reference.

### BACKGROUND

1. Field

One embodiment of the invention relates to an information processing apparatus including a radio communication device and, more particularly, to an information processing apparatus capable of discriminating a direction in which a reception sensitivity of antennas of the radio communication device is optimum and a control method of the information processing apparatus.

2. Description of the Related Art

In general, as for a radio communication apparatus employing a personal computer, etc. as disclosed in, for example, Jpn. Pat. Appln. KOKAI Publication No. 8-316904, a user randomly moves the terminal to various locations to improve the reception sensitivity, stops the movement at a location where the sensitivity accidentally becomes better, and uses the apparatus at the location. In addition, location information is obtained with a GPS, etc. but is not used for the improvement of the reception sensitivity.

According to the technique, the location where the reception sensitivity is good must be found by randomly changing the direction in a user's distance to improve the reception sensitivity of antennas, etc. employed for the radio communication. In addition, according to the technique disclosed in Jpn. Pat. Appln. KOKAI Publication No. 8-316904, the received location information is not used for the improvement of the reception sensitivity.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a configuration of a notebook PC equipped with an information processing apparatus according to an embodiment of the present invention;

FIG. 2 is a block diagram showing a configuration of the notebook PC;

FIG. 3 is a flowchart of a control method of displaying a direction of an optimum reception sensitivity from obtained information;

FIG. 4 is an illustration of a direction of an optimum reception sensitivity;

FIG. 5 is an illustration of a direction of an optimum reception sensitivity;

FIG. 6 is a flowchart of a control method of displaying an direction in which a reception sensitivity is optimum, from obtained information, by using smart antennas having a function of adjusting directivity; and

FIG. 7 is an illustration of displaying a direction of an optimum reception sensitivity on a task bar.

### DETAILED DESCRIPTION

Various embodiments according to the invention will be described hereinafter with reference to the accompanying drawings. In general, according to one embodiment of the invention, an information processing apparatus capable of discriminating a direction in which a reception sensitivity of antennas is optimum and a method of controlling the information processing apparatus.

An embodiment of the present invention will be explained below with reference to the accompanying drawings.

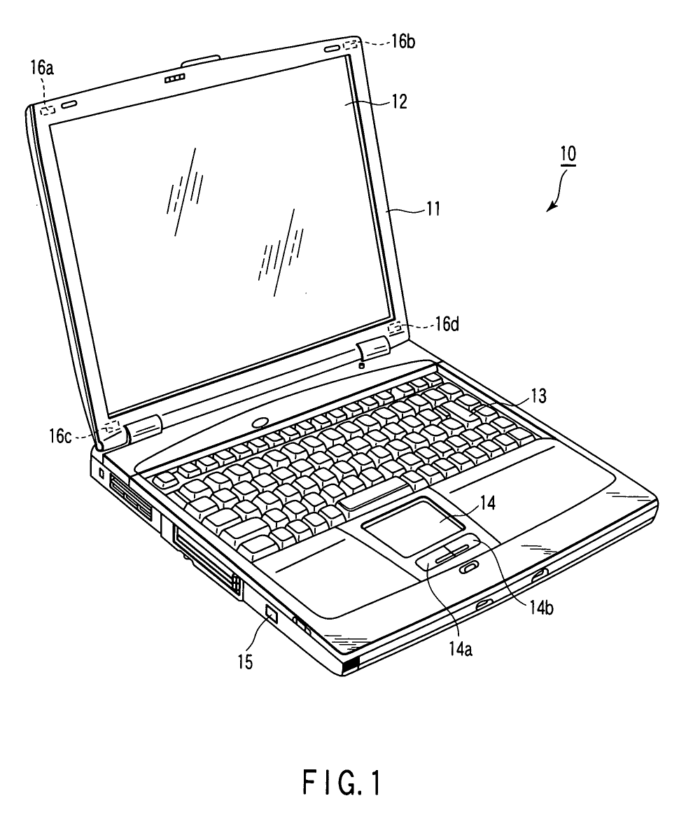

FIG. 1 shows a system configuration of an information processing apparatus according to an embodiment of the present invention. The information processing apparatus is implemented as a battery-operated notebook computer 10.

The computer 10 is composed of a computer body and a display unit 11 as shown in FIG. 1. A display device composed of an LCD (Liquid Crystal Display) is embedded in the display unit 11. A display screen 12 of the LCD is located approximately at the center of the display unit 11. Antennas 16a to 16d for radio communication are built in the display unit 11. The antennas may be, for example, smart antennas capable of adjusting the directivity.

The display unit 11 is attached to the computer 10 so as to freely pivot between an opened position and a closed position. The main body of the computer 10 has a housing shaped in a thin box, and comprises a keyboard 13 on a top face, a touch pad 14 and two buttons 14a, 14b on a palm rest, an optical drive unit 15 on a side face, etc.

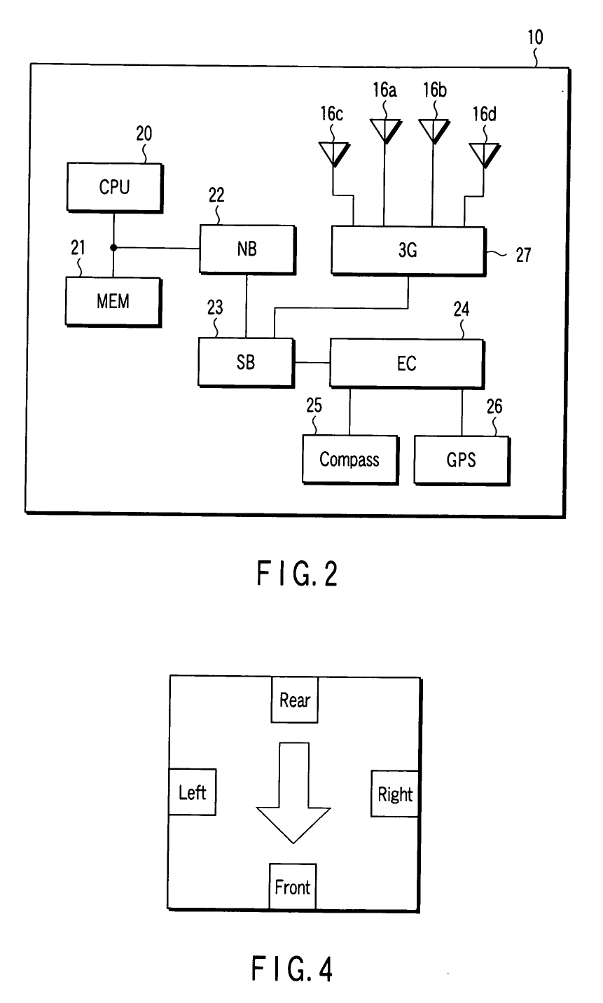

FIG. 2 is a block diagram showing the configuration of the computer 10.

The computer 10 comprises a CPU (Central Processing Unit) 20, a main memory (MEM) 21, a north bridge (NB) 22, a south bridge (SB) 23, an embedded controller (EC) 24, an electronic compass 25, a GPS module 26, a 3G communication unit 27, the antennas 16a to 16d, etc.

The CPU 20 is a processor controlling the operations of the computer, and executes various kinds of programs (operating system and application systems) loaded on the main memory 24 by a HDD (hard disk drive) (not shown). In addition, the CPU 20 also executes the BIOS (Basic Input Output System) stored in a BIOS-ROM (not shown). The BIOS is a program for controlling the hardware.

The EC 24 is a one-chip microcomputer on which an embedded controller for power management and a keyboard controller controlling the keyboard (KB) 13 and the touch pad 14 are integrated. The electronic compass 25 and the GPS module 26 are connected to the EC 24. The EC 24 has a function of controlling power-on/power-off of the computer 10, in cooperation with a power supply controller, in response to the user's operation of the power button.

The 3G communication unit 27 receives data via the antennas 16a to 16d connected to the unit and processes the received data. The antennas 16a to 16d can possess the directivity according to the reception sensitivity, etc. For example, one of the antennas 16a to 16d close to the direction of a good reception sensitivity can be used. If the direction of the reception sensitivity is changed, the antenna can be switched to the other antenna close to the changed direction.

The electronic compass 25 obtains bearing information of the direction of the computer 10. The GPS module 26 receives location information from a satellite. When the location information is obtained by the GPS module 26, the computer 10 transmits the obtained location information to a server. The server analyzes the location information, and transmits information on the location of the own apparatus of the computer 10 and the location information of the server to the computer 10. The GPS module 26 may be built in the 3G communication unit 27.

A method of controlling the above-constructed information processing apparatus of the present invention is explained.

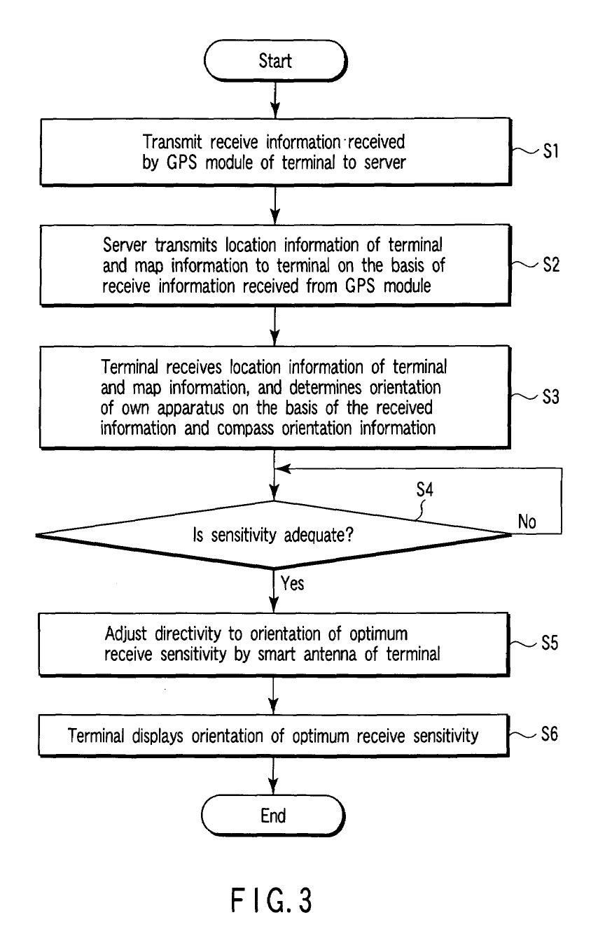

FIG. 3 is a flowchart of a control method to which the information processing apparatus according to the embodiment of the present invention is applied.

The CPU 20 transmits the receive information (location information) received from the GPS module 26 via the 3G communication unit 27 (step S1). On the basis of the receive information (location information), the server analyzes the information on the location of the own apparatus of the computer 10, and transmits to the computer 10 the analyzed information on the location of the own apparatus, the location information of the server, and map information including a relationship in location between the information on the location of the own apparatus and the location information of the server (step S2).

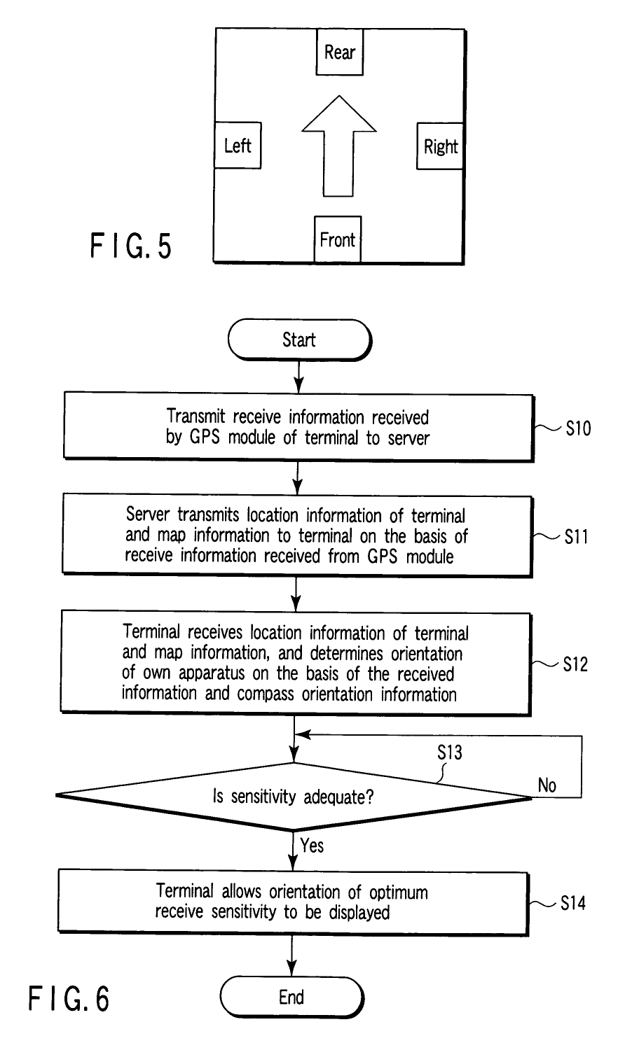

The computer 10 receives the location information of the own apparatus, the location information of the server, the bearing information obtained from the electronic compass 25, and the reception sensitivity information obtained from the 3G communication unit 27, and discriminates the direction of the own apparatus by using the location information of the own apparatus, the location information of the server, and the bearing information (step S3). Subsequently, the computer 10 discriminates whether or not the reception sensitivity of the 3G communication unit 27 is adequate to conduct communications with the server (step S4). If it is discriminated that the reception sensitivity is adequate (YES of step S4), the 3G communication unit 27 executes a processing for activating an antenna close to the discriminated optimum direction, for example, the antenna 16a (step S5) and allows the discriminated optimum direction to be displayed on the display unit 11 (step S6). For example, if a rear direction of the display unit 11 is referred to as “rear”, a touch pad 14 side direction of the computer 10 is referred to as “front”, a right side direction of the computer 10 is referred to as “right” and a left side direction of the computer 10 is refereed to as “left” in a state in which the display unit 11 of the computer 10 is opened, the “front” direction is the optimum direction in an example shown in FIG. 4 and the “rear” direction is the optimum direction in an example shown in FIG. 5.

Thus, the optimum direction in which the reception sensitivity of the antennas is optimum can be discriminated and the directions of the antennas can be automatically adjusted.

Next, a modified example of the above embodiment is described.

FIG. 6 is a flowchart for explanation of the modified example of the above embodiment.

In the modified example, smart antennas capable of adjusting the directivity are not used but general antennas are used.

Step S10 to step S13 correspond to step S1 to step S5 of the above embodiment, respectively. The computer 10 allows the discriminated optimum direction to be displayed on the display screen 12 (step S14). The user watches the display of the discriminated optimum direction and executes operations of changing the direction of the arrangement of the computer 10, etc. while recognizing the direction in which the reception sensitivity is considered optimum.

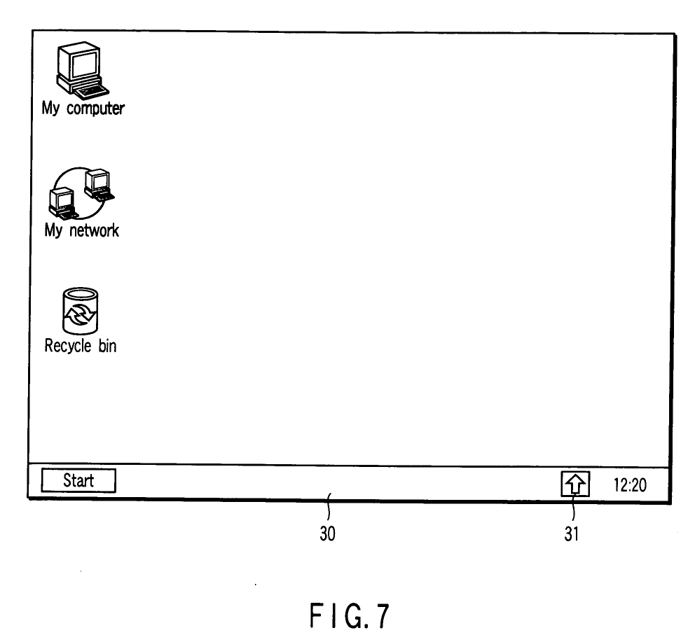

In an example shown in FIG. 7, the discriminated optimum direction may be displayed in a great size at the center of the display screen by using an application or may be displayed at any time in a form of an icon 31, etc. on a task bar 30, etc.

Thus, the user can easily recognize the optimum reception sensitivity since the reception sensitivity of the antennas indicates the optimum direction on the display screen 12.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
communication means for receiving location information of the own apparatus and location information of an external apparatus configured to make communications with the own apparatus;
obtaining means for obtaining bearing information;
discrimination means for discriminating a direction of the own apparatus to the external apparatus, by using the location information of the own apparatus and the location information of the external apparatus received by the communication means, and the bearing information obtained by the obtaining means; and
a display unit which displays the direction discriminated by the discrimination means if sensitivity of a radio wave received by the communication means is sensitivity which allows the own apparatus to make communications with the external apparatus.

2. The apparatus according to claim 1, wherein the communication means are antennas configured to adjust directivity and adjust the directivity in accordance with information on the direction.

3. The apparatus according to claim 1, wherein the obtaining means is an electronic compass.

4. The apparatus according to claim 1, wherein the discrimination means is means for discriminating the direction of the own apparatus to the external apparatus, by using the location information of the own apparatus and the location information of the external apparatus received with predetermined intervals, and the bearing information obtained by the obtaining means.

5. The apparatus according to claim 1, wherein the discrimination means receives the location information of the own apparatus and location information of a server from the server with predetermined intervals and discriminates an optimum direction of the communication means.

6. A method of controlling an information processing apparatus, comprising communication means for receiving location information of the own apparatus and location information of an external apparatus configured to make communications with the own apparatus, and obtaining means for obtaining bearing information,
the method comprising:
discriminating a direction of the own apparatus to the external apparatus, by using the location information of the own apparatus and the location information of the external apparatus received by the communication means, and the bearing information obtained by the obtaining means; and
displaying the direction discriminated by the discrimination means if sensitivity of a radio wave received by the communication means is sensitivity which allows the own apparatus to make communications with the external apparatus.

7. The method according to claim 6, wherein the communication means are antennas configured to adjust directivity and adjust the directivity in accordance with information on the direction.

8. The method according to claim 6, wherein the discrimination discriminates the direction of the own apparatus to the external apparatus, by using the location information of the own apparatus and the location information of the external apparatus received with predetermined intervals, and the bearing information obtained by the obtaining means.

9. The method according to claim 6, wherein the discrimination receives the location information of the own apparatus and location information of a server from the server from the external apparatus with predetermined intervals and discriminates an optimum direction of the communication means.
